(19) United States
(12) Patent Application Publication
(10) Pub. No.: US 2013/0169507 A1
(43) Pub. Date: Jul. 4, 2013

(54) WIRELESS COMMUNICATION DEVICE WITH SENSOR-BASED ANTENNA SELECTION

(71) Applicants: CHENG-HUNG KO, Shindian (TW); HAO-YING CHANG, Shindian (TW); CHUAN-CHOU CHI, Shindian (TW)

(72) Inventors: CHENG-HUNG KO, Shindian (TW); HAO-YING CHANG, Shindian (TW); CHUAN-CHOU CHI, Shindian (TW)

(73) Assignee: FIH (HONG KONG) LIMITED, Kowloon (HK)

(21) Appl. No.: 13/601,888

(22) Filed: Aug. 31, 2012

(30) Foreign Application Priority Data
Dec. 30, 2011 (TW) 100149934

(51) Int. Cl. H01Q 3/24

(52) U.S. Cl. 343/876

(57) ABSTRACT

An exemplary wireless communication device includes a housing, a first antenna, a second antenna, a switch, and a radio frequency (RF) circuit. The housing includes a first holding portion corresponding to the second holding portion and a second holding portion corresponding to the first holding portion. The RF circuit is selectively connectable to the first antenna or the second antenna via the switch. The sensor is electrically connected to the switch. The sensor senses a state of the housing, wherein the state of the housing is one of position of the housing and proximity of a user's hand to one of the first antenna and the second antenna, and the sensor controls the switch to select the first antenna or the second antenna to connect to the RF circuit to transmit and receive signals wirelessly according to the sensed state of the housing.

### BACKGROUND

1. Technical Field

The disclosure generally relates to wireless communication devices, and particularly to a wireless communication device having an antenna switch function controlled by a sensor.

2. Description of Related Art

To improve communication quality, wireless communication devices usually include two coplanar antennas, each of which is able to transmit and receive signals wirelessly. Before either of the antennas transmits signals to a receiver, the signal intensity of each antenna is compared with a reference signal intensity. One of the antennas having a better radiation performance according to the comparison result is then selected by a selector of the wireless communication device to connect to the receiver.

However, when a user holds the wireless communication device, the user's fingers or hand might be positioned where they interfere with both the coplanar antennas. If this happens, the selector of the wireless communication device cannot rapidly select which of the antennas has the better radiation performance. Therefore, the communication quality of the wireless communication device cannot be effectively optimized as desired.

In view of the above, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic, isometric view of a wireless communication device, according to an exemplary embodiment of the disclosure.

FIG. 2 is a block diagram of the wireless communication device, according to the exemplary embodiment of the disclosure.

FIG. 3 is a plan view of the wireless communication device of FIG. 1 positioned at a first position.

FIG. 4 is a plan view of the wireless communication device of FIG. 1 positioned at a second position.

### DETAILED DESCRIPTION

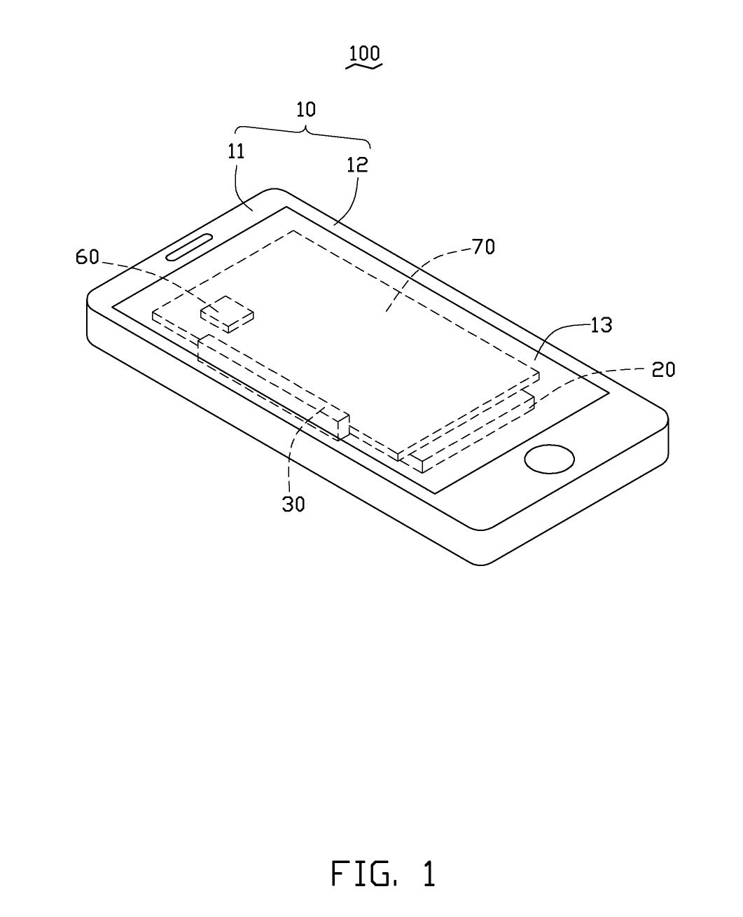

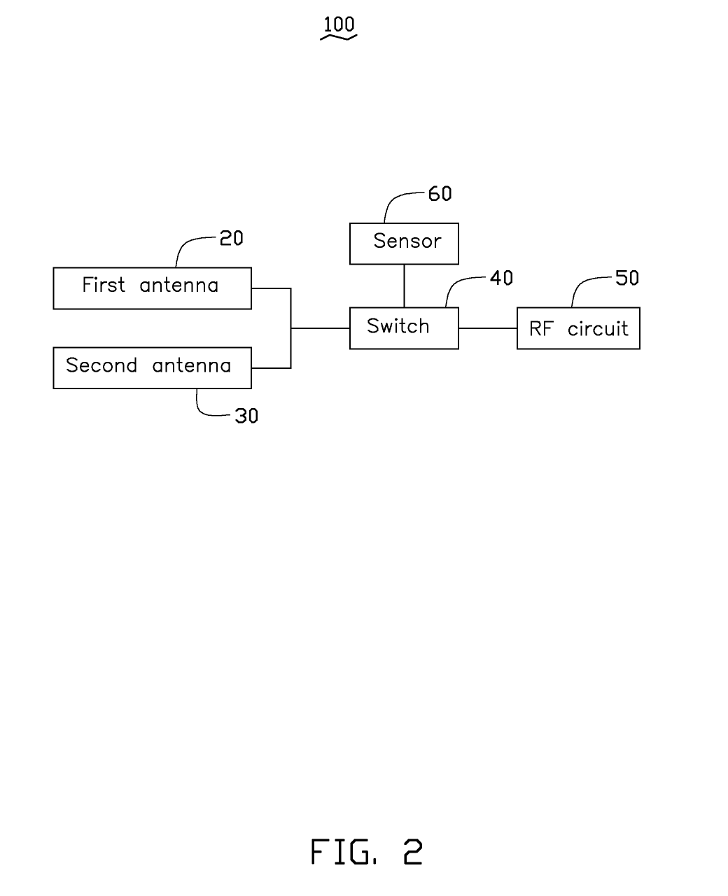

FIG. 1 is a schematic, isometric view of a wireless communication device 100, according to an exemplary embodiment of the disclosure. The wireless communication device 100 includes a housing 10, a first antenna 20, a second antenna 30, a switch 40, a radio frequency (RF) circuit 50 (shown in FIG. 2), and a sensor 60. The wireless communication device 100 may be a portable electronic device such a mobile phone, a personal digital assistant (PDA), or a tablet computer such as an iPAD™.

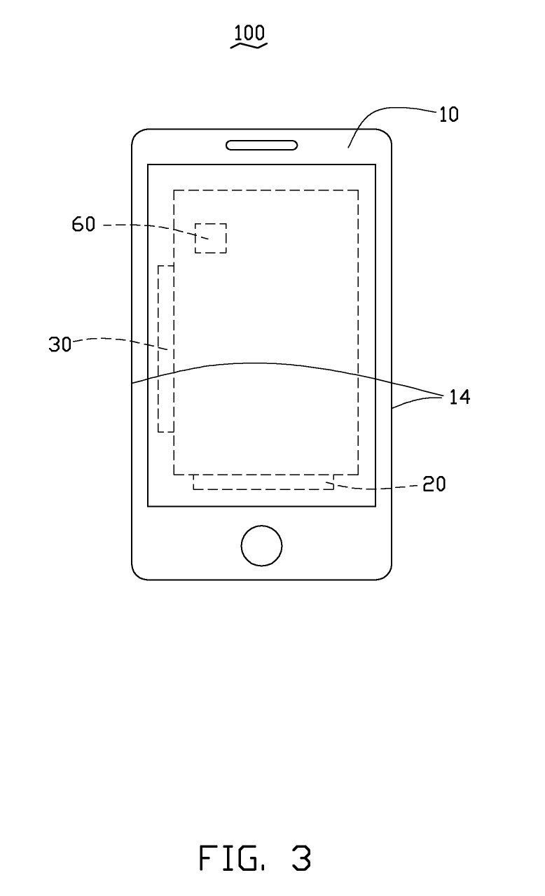

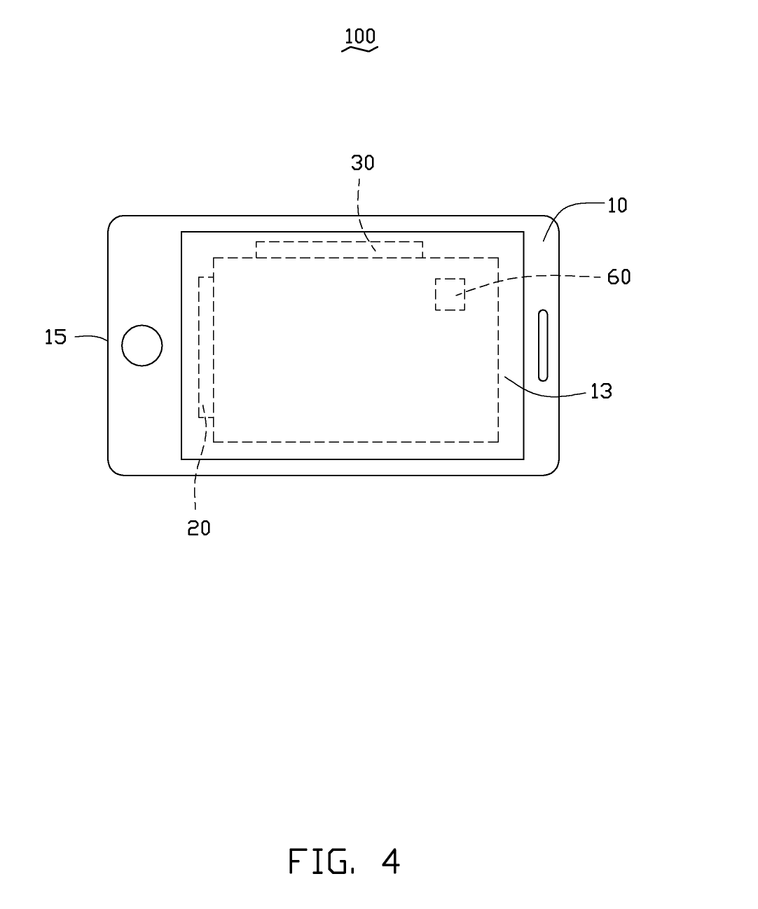

The housing 10 is substantially a rectangular, hollow board, and includes two opposite end portions 11 and two opposite side walls 12 perpendicularly interconnecting the two end portions 11. A display 13 is positioned on a middle portion of a top surface of the housing 10. Referring also to FIGS. 3 and 4, in one embodiment, the housing 10 also includes a first holding portion 14 and a second holding portion 15. A user may hold the first holding portion 14 or the second holding portion 15 while using the wireless communication device 100. In this embodiment, the two side walls 12 cooperatively form the first holding portion 14, and one of the two end portions 11 forms the second holding portion 15.

When the first holding portion 14 is held by the user, typically, the wireless communication device 100 is positioned at a first position where the display 13 is in a longitudinal (or portrait) state, as shown in FIG. 3. When the second holding portion 15 is held by the user, typically, the wireless communication device 100 is positioned at a second position where the display 13 is in a wide (or landscape) state, as shown in FIG. 4. When the wireless communication device 100 changes from the first position to the second position, the wireless communication device 100 is rotated 90 degrees clockwise.

The first antenna 20 and the second antenna 30 are schematically shown in FIG. 1, and may be conventional antennas. The first antenna 20 is positioned at one of the end portions 11, adjacent to a circuit board (not labeled) mounted in the housing 10. The first antenna 20 corresponds to the second holding portion 15. The second antenna 30 is positioned at one of the side walls 12, adjacent to the circuit board. The second antenna 30 corresponds to the first holding portion 14.

When the first holding portion 14 is held by the user, the first antenna 20 can work normally and wirelessly transmit and receive signals; and the second antenna 30 is interfered with by a hand (or fingers) of the user, and has a relatively weak radiation performance. When the second holding portion 15 is held by the user, the first antenna 20 is interfered with by the hand (or fingers) of the user, and has a relatively weak radiation performance; and the second antenna 20 can work normally and wirelessly transmit and receive signals.

Referring to FIG. 2, the first antenna 20 and the second antenna 30 are selectively connected to the RF circuit 50 via the switch 40. The RF circuit 50 selects the first antenna 20 or the second antenna 30 to transmit and receive signals via the switch 40. The sensor 60 is electrically connected to the switch 40. The sensor 60 senses positions of the wireless communication device 100 itself, or senses positions of a user's hand on the wireless communication device 100, and switches the switch 40 according to the sensed positions.

In a first embodiment, the sensor 60 is an acceleration sensor positioned in the housing 10. The acceleration sensor senses movement of the wireless communication device 100, and determines the position of the wireless communication device 100 according the movement. For example, when the acceleration sensor senses that the wireless communication device 100 is rotated clockwise 90 degrees from a longitudinal position (the first position shown in FIG. 3) to a wide position (the second position shown in FIG. 4), the acceleration sensor determines that the wireless communication device 100 is at the second position.

In a second embodiment, the sensor 60 is a proximity sensor positioned in the housing 10 adjacent to the second antenna 30 (as illustrated in FIGS. 3 and 4). The proximity sensor senses whether the user is close to the second antenna 30 or not. For example, when the proximity sensor senses that the user is close to the second antenna 30 and is therefore holding the first holding portion 14, the proximity sensor determines that the wireless communication device 100 is in a first holding state (often, the first holding state will correspond to the wireless communication device 100 being at the first position). Otherwise, when the proximity sensor does not sense that the user is close to the second antenna 30 and is therefore not holding the first holding portion 14, the proximity sensor determines that the wireless communication device 100 is in a second holding state. Typically, in the second holding state, the user is holding the second holding portion 15 (and often, the second holding state will correspond to the wireless communication device 100 being at the second position). In other embodiments, the proximity sensor may be positioned in the housing 10 adjacent to the first antenna 20, and function in a manner similar and corresponding to the functioning described above.

The sensor 60 controls the switch 40 to select the first antenna 20 or the second antenna 30 to connect to the RF circuit 50, according to the sensed position of the wireless communication device 100 itself or the sensed position of a user's hand on the wireless communication device 100. In this embodiment, when the wireless communication device 100 is positioned at the first position or is in the first holding state, the first antenna 20 is selected to connect to the RF circuit 50; and when the wireless communication device 100 is positioned at the second position or is in the second holding state, the second antenna 30 is selected to connect to the RF circuit 50.

Thus, one of the first and second antennas 20, 30 having the better radiation performance can be selected to transmit and receive signals. Accordingly, the wireless communication device 100 can achieve improved communication quality, no matter whether it is positioned at the first position or at the second position, and no matter whether it is in the first holding state or in the second holding state.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A wireless communication device, comprising:
a housing comprising a first holding portion and a second holding portion for a user to selectably hold either the first holding portion or the second holding portion;
a first antenna corresponding to the second holding portion;
a second antenna corresponding to the first holding portion;
a switch;
a radio frequency (RF) circuit selectively connectable to the first antenna or the second antenna via the switch; and
a sensor electrically connected to the switch, the sensor sensing a state of the housing, wherein the state of the housing is one of a position of the housing and proximity of a user's hand to one of the first antenna and the second antenna, and the sensor controlling the switch to select the first antenna or the second antenna to connect to the RF circuit to transmit and receive signals wirelessly according to the sensed state of the housing.

2. The wireless communication device of claim 1, wherein when the sensor senses that the housing is positioned at a first position, the switch is controlled to select the first antenna to connect to the RF circuit; and when the sensor senses that the housing is positioned at a second position, the switch is controlled to select the second antenna to connect to the RF circuit.

3. The wireless communication device of claim 2, wherein when the first holding portion is held by the user, the housing is positioned at the first position.

4. The wireless communication device of claim 2, wherein when the second holding portion is held by the user, the housing is positioned at the second position.

5. The wireless communication device of claim 1, wherein two side walls of the housing cooperatively form the first holding portion.

6. The wireless communication device of claim 1, wherein an end portion of the housing forms the second holding portion.

7. The wireless communication device of claim 2, further comprising a display positioned on a surface of the housing, wherein when the housing is positioned at the first position, the display is in a longitudinal state.

8. The wireless communication device of claim 2, further comprising a display positioned on a surface of the housing, wherein when the housing is positioned at the second position, the display is in a wide state.

9. The wireless communication device of claim 1, wherein the sensor is an acceleration sensor positioned in the housing, and the acceleration sensor senses the position of the housing.

10. The wireless communication device of claim 1, wherein the sensor is a proximity sensor positioned in the housing, and the proximity sensor senses the proximity of a user's hand to one of the first antenna and the second antenna.

11. The wireless communication device of claim 10, wherein the proximity sensor is adjacent to one of the first antenna and the second antenna.

12. A wireless communication device, comprising:
a housing comprising a first holding portion and a second holding portion;
a first antenna corresponding to the second holding portion;
a second antenna corresponding to the first holding portion;
a switch;
a radio frequency (RF) circuit electrically connectable to the first antenna or the second antenna via the switch; and
a proximity sensor electrically connected to the switch; wherein when the proximity sensor senses that the first holding portion is held by a user, the proximity sensor controls the switch to select the first antenna to connect to the RF circuit; and when the proximity sensor senses that the second holding portion is held by a user, the proximity sensor controls the switch to select the second antenna to connect to the RF circuit.

13. The wireless communication device of claim 12, wherein when the first holding portion is held by the user, the second antenna is interfered with by the user.

14. The wireless communication device of claim 12, wherein when the second holding portion is held by the user, the first antenna is interfered with by the user.

15. The wireless communication device of claim 13, wherein two side walls of the housing cooperatively form the first holding portion.

16. The wireless communication device of claim 14, wherein an end portion of the housing forms the second holding portion.

17. A wireless communication device, comprising:
a housing comprising first holding portions at opposite lateral sides thereof and a second holding portion at an end thereof between the opposite lateral sides for a user to selectably hold either the first holding portions or the second holding portion;
a first antenna positioned adjacent to the second holding portion;
a second antenna positioned adjacent to one of the first holding portions;
a switch;
a radio frequency (RF) circuit selectively connectable to the first antenna or the second antenna via the switch; and
a sensor electrically connected to the switch, the sensor sensing a state of the housing, wherein the state of the housing is one of an orientation of the housing and proximity of a user's hand to one of the first antenna and the second antenna, and the sensor controlling the switch to select one of the first antenna and the second antenna to connect to the RF circuit to transmit and receive signals wirelessly according to the sensed state of the housing.

18. The wireless communication device of claim 17, wherein the sensor is positioned in the housing, and is one of an acceleration sensor and a proximity sensor, the acceleration sensor senses the orientation of the housing, and the proximity sensor senses the proximity of a user's hand to one of the first antenna and the second antenna.

19. The wireless communication device of claim 17, wherein when the sensor senses that the housing has a first orientation, the switch is controlled to select the first antenna to connect to the RF circuit; and when the sensor senses that the housing has a second orientation, the switch is controlled to select the second antenna to connect to the RF circuit.

20. The wireless communication device of claim 19, wherein when the first holding portions are held by the user, the housing has the first orientation; and when the second holding portion is held by the user, the housing has the second orientation.
